(19) United States
(12) Patent Application Publication
(10) Pub. No.: US 2025/0314950 A1
(43) Pub. Date: Oct. 9, 2025

(54) Animal Held Media Capture Apparatus

(71) Applicant: PUPSNAP VENTURES LLC, Glen Arm, MD (US)

(72) Inventors: Matthew Reichman, New York, NY (US); Jacob Singer, Portland, OR (US)

(21) Appl. No.: 19/171,807

(22) Filed: Apr. 7, 2025

Related U.S. Application Data
(60) Provisional application No. 63/631,633, filed on Apr. 9, 2024.

(51) Int. Cl. G03B 17/56; A01K 15/02; F16M 13/04

(52) U.S. Cl. CPC G03B 17/561; A01K 15/025; F16M 13/04; F16M 2200/06

(57) ABSTRACT

An animal held media capture apparatus which features at least one means for securing at least one capture device to an elongated piece that is attached to a bite apparatus that encourages the animal to engage with and retain the bite apparatus within the animal's mouth so that images, video, audio, and other media may be recorded from the animal's point of view.

### CROSS REFERENCE TO RELATED APPLICATIONS

This application claims the benefit of U.S. Provisional Patent Application No. 63/631,633, filed Apr. 9, 2024, and titled “ANIMAL HELD IMAGE CAPTURE APPARATUS,” the contents of which are hereby incorporated in their entirety.

### FIELD OF THE INVENTION

The present invention generally relates to apparatuses that enable media footage to be streamed and/or recorded from a pet or animal's point of view (“POV”). More particularly, the present invention relates to pet or animal POV image capture, audio capture, streaming, and/or recording (collectively “media”) apparatuses that are designed to be held by the pet or animal's mouth and that are capable of fitting and using a variety of camera devices.

### BACKGROUND OF THE INVENTION

Many people love to examine media (especially watching videos) from the POV of their pets or animals (such as wild animals or zoo animals). Moreover, such media may be informative of the pet or animal's daily life including activities, interactions, diet, and rest. This generated media may be used for more than human entertainment such as for diagnosis, research, and other beneficial endeavors for the particular animal or its or other species.

Several devices exist to be carried by animals (often merely “worn”) while streaming or capturing media. Such devices are typically mounted via a harness with a capture device being located most typically above the animal's back, on their chest, or on top of their head. The location of the capture device in these setups does not capture the truest POV that is possible. Rather, there exists a need for a capture device that is located at about the animal's eye level and in front of the animal.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to an animal held media capture apparatus comprising an elongated piece having two distal ends; a bite apparatus on one distal end of the elongated piece and the bite apparatus being designed to be engaged by an animal and is adapted to encourage that engagement and promote retainment within the animal's mouth; a first means for securing a capture device on the other distal end of the elongated piece opposite of the bite apparatus; a second means for securing a capture device to the elongated piece between the two distal ends; and wherein the animal held media capture apparatus is made of animal safe materials.

The subject matter disclosed and claimed here, in some embodiments of the present invention, relates to an animal held media capture apparatus comprising a bite apparatus having two distal ends and wherein one distal end is engaged by an animal and is adapted to encourage that engagement and promote retainment within the animal's mouth; a first means for securing a capture device on the other distal end of the bite apparatus not engaged by the animal and adapted to receive a capture device to provide media from the animal's point-of-view; and wherein the animal held media capture apparatus is made of animal safe materials.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is an isometric view of a bottom side of one embodiment of the present invention.

FIG. 2 is an isometric view of a top side of one embodiment of the present invention.

FIG. 3 is a view from above one embodiment of the present invention.

FIG. 4 is a view from below one embodiment of the present invention.

FIG. 5 is a view of a front of one embodiment of the present invention.

FIG. 6 is a view of a back of one embodiment of the present invention.

FIG. 7 is an exploded, isometric view of one embodiment of the present invention featuring additional security for a capture device.

FIG. 8A-8D are multiple embodiments of the present invention featuring a variety of capture device connections and animal engagement mechanisms.

FIGS. 9A and 9B feature an embodiment of the present invention having a detachable first means for securing a capture device.

FIGS. 10A and 10B feature an embodiment of the present invention having a detachable first means for securing a capture device.

FIGS. 11A and 11B feature an embodiment of the present invention having a detachable first means for securing a capture device.

FIGS. 12A and 12B feature an embodiment of the present invention having a detachable first means for securing a capture device.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

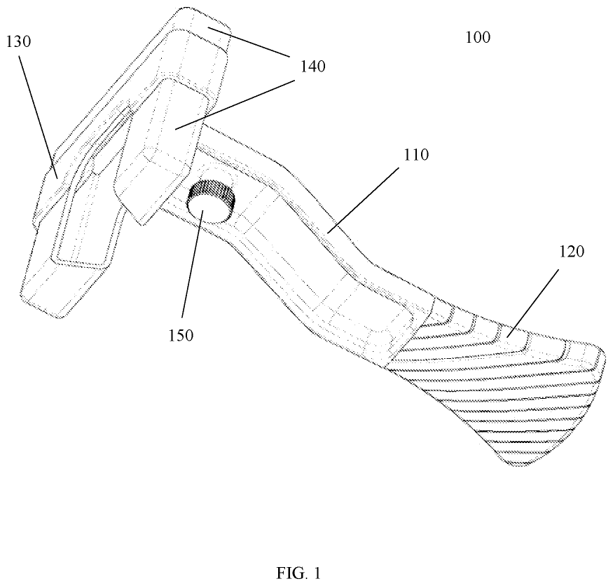

FIG. 1 is an isometric view of a bottom side of one embodiment of the present invention. In some embodiments and by way of example, the present invention is an animal held media capture apparatus 100 (media includes photos, video, audio, and other common recordable pieces of data captured by consumer capture devices) comprising an elongated piece 110 having two distal ends, one of the distal ends is connected to a bite apparatus 120, the other distal end includes a first means for securing a capture device 130 which may be aided by a capture device support structure 140, and the elongated piece 110 may further include a second means for securing a capture device 150. The first means for securing a first capture device 130 and the second means for securing a second capture device 150 may individually secure two separate capture devices or they may work in tandem to secure a single capture device.

All versions of the animal held media capture apparatus should be lite enough so that the animal using the device is not overly burdened by the weight nor cumbersomeness of the apparatus. As such, animal held media capture apparatuses should be designed with considerations such as a range of weights for a desired set of animals to use, the length of the apparatus so that it does not cause the animal using it to lose balance, the width, strength, and depth of the animal's mouth for the bite apparatus, the weight of the desired capture device to be couple with the animal held media capture apparatus, and other considerations centered around the dimensions and weight of the device in comparison to the animal using it.

Images, video, audio, and other data captured by the animal held media capture apparatus 100 may be single images, multiple images, video recordings, video streams to another device or over a network, image sensor data, audio data, similar capturable data, and combinations thereof. Audio may also commonly be captured by devices capable of doing so (such as cellular phones), as with most video recordings including audio recordings.

The elongated piece 110 may be a rod or elongated substantially flat piece that is straight or angled (in one or more places) as to provide comfort to a holder (the “holder” being a pet or animal) and stability while the apparatus is in use. The elongated piece 110 is ideally made of sturdy yet lightweight materials such as plastics (structurally reinforced with metal rods in some embodiments).

In alternative embodiments, the elongated piece 110 may have settable and lockable hinges or hinged joints so that a user (the human preparing the device for the animal) may adjust the angle of the capture device and its relation to the line of vision of the animal. These hinged features may be settable at prescribed intervals or locked on a more freely rotating hinge.

In more alternative embodiments, the elongated piece 110 may be comprised of a bendable pole. Such flexibility may be accomplished in several ways including using materials such as aluminum (which is bendable yet resistant to damage) wrapped in rubber or silicone, having at least one ball and socket joint allowing for movement and rotation, and other methods which allow for the elongated piece 110 to be reoriented without being damaged and having resistant to being undesirably placed out of that orientation during use. The user may arrange, shape, contort, bend, twist, or otherwise manipulate the elongated piece 110 into a desired orientation. This may allow the animal held media capture apparatus 100 to function as a media capture device stand (having similar functionality to a tripod).

Further embodiments may also include telescoping capabilities so that the length of the elongated piece 110 may be adjusted as desired by the user. Even further embodiments may feature one or more light sources on the elongated piece for illuminating the surroundings and/or the animal.

The animal orally engages (or “bites”) down on the bite apparatus 120 (depicted as a bite plate). The bite apparatus 120 may include replaceable items such as “bite-down” pads which may be designed with grooves, soft spikes, textured patches, form-fitted grooves, and other structures. Alternatively, these structures may be permanently affixed to the bite apparatus 120. The form of all such structures is to serve a few purposes such as: (1) being desirable for engagement by the holder (mouth/tongue feel), (2) providing a secure means for the holder to retain possession and control of the animal held media capture apparatus 100 while moving, (3) being resistant to damage during use, and (4) being easy to clean after use. The bite apparatus 120 is only one example of a family of bite apparatuses that may be desired to be used based on several factors including: the type of animal, the size of the animal, the type of bite and strength of the bite, the user's desires, the user's preference, the animal preference, etc.

In some embodiments, the bite apparatus 120 may be adapted to be or be attached to a desirable object or attractant to encourage animal engagement with the bite apparatus 120 or stimulate the animal (tactile, auditory, smell, taste, etc.). For example, a squishable toy component may comprise a bite plate or may wrap, encompass, encircle, or otherwise cover all or a portion of the bite apparatus 120. As another example, the bite apparatus 120 may include a treat holder portion that encourages the animal to play with the bite apparatus 120 in order to get treats to dislodge from the treat holder.

In further embodiments, the bite apparatus 120 may be flavored as to encourage animal engagement. Exemplary flavors that are common and widely used include chicken, beef, and bacon. One method of incorporating these flavors into the bite apparatus 120 is by folding in the desired seasoning or flavoring to animal safe silicone or rubber prior to forming the bite apparatus 120 in a process such as injection molding or subtractive manufacturing, among other methods. Flavored bite apparatuses may increase the duration of use by the animal and enjoyment of said use for the animal.

It should be noted that not only the bite apparatus 120, which engages with the animal's mouth, but all parts of the animal held media capture apparatus 100 may be made of animal safe materials such as BPA-free plastics, natural rubbers, silicone, and the like. One reason for this is because the animal may disengage the bite apparatus 120 and then bite down on another part of the animal held media capture apparatus 100.

The bite apparatus 120 may be permanently affixed to the distal end of the elongated piece 110 or it may be detachable. Detachable versions may allow for softer materials to be used to increase the animal's enjoyment and comfort while using the animal held media capture apparatus 100. Softer bite apparatuses are more likely to be damaged; therefore, needing replacement. So, softer bite apparatuses may be attached to the distal end of the elongated piece 110 by merely a snug fit or some further attachment means such as adhesive, fasteners, hole-and-peg designed features on the elongated piece 110 and the bite apparatus 120, and other common means which would allow the animal to use the animal held media capture apparatus 100 without danger of undesirably dislodging the bite apparatus 120 from the elongated piece 110.

The first means for securing a capture device 130 includes clamps, receivers, rails, straps, female receiving screw holes, pegs or screws and other fasteners, tailor-made structures (such as the depicted retaining ring) adapted to fit and/or couple with or to a capture device, and combinations thereof. Capture devices include standalone cameras, camcorders, sensors, specialized equipment (such as a “GoPro™”), tablets, cell phones, and other mobile and personal devices including a camera, etc. The first means for securing a capture device 130 may be made of one or more pieces and of suitable materials for holding delicate commercial goods such as capture devices. These materials include rubber, silicone, plastic, metal (usually with a rubber or silicone exterior layer), other suitable materials, and combinations thereof. The first means for securing a capture device 130 may range from coupling pieces such as a more generic and retractable holding mechanism for the capture device (having ratcheting locks or other pressure-oriented engagement mechanisms) to specially made equipment that may only hold one model of the capture device (such as a cell phone or camera).

In alternative embodiments, the first means for securing a capture device 130 may be removable from the elongated piece 110 and comprise an attachment mechanism for securing the first capture device to the distal end of the elongated piece 110. This attachment mechanism, in these embodiments, may include a threaded peg that the capture device is capable of coupling with, or it may be other coupling means including quick-release mechanisms (such as a quick-release button operably mechanic with a hole-and-pin connector), compression connectors, suction connectors, adhesive connectors, fasteners, and so on.

The first means for securing a capture device 130 may include or couple with a capture device support structure 140. The capture device support structure 140 should, in all embodiments, be adapted to receive at least one type of capture device and secure that capture device safely within the first means for securing a capture device 130. This capture device support structure 140 may include form-fitting molds, protective cages, cases, covers, or plates for the device, straps, bands, clamps, and combinations thereof. The depicted embodiment features this capture device support structure 140 in the form of a silicone, rubber, or plastic piece molded to securely hold a cell phone. The capture device support structure 140 may further feature bumps or braces that snugly engage the inserted cell phone. This is to prevent damage and slippage of the cell phone during use because the animal using the apparatus is unlikely to take the care that a human would give to a sensitive electronic device such as a cell phone, camera, or sensor.

The capture device support structure 140 may cover part or the whole of the capture device. If covering the whole of the capture device, the capture device support structure 140 may include transparent materials such as plastic or silicone so that the encompassed capture device may record images or video. Further, the capture device support structure 140 may have an interior which houses the capture device and an exterior that is adapted to or contains securing mechanisms to secure the capture device support structure 140 into the first means for securing a capture device 130. These securing mechanisms include slotted rails and releasable latches, snuggly fitting within the first means for securing a capture device 130 (example, a rubberized exterior that slightly compresses when the capture device support structure 140 is inserted into the first means for securing a capture device 130), clamps, and so forth.

In further alternative embodiments, the first means for securing a capture device 130 may include common attachment mechanisms for connecting with other consumer products such as “selfie” sticks, poles, rods, bars (such as on a bicycle handlebar), tripods, and other items which the consumer may wish to take and use the capture device and/or the capture device support structure 140 with. This versatility allows the user to acquire media with the present invention instead of without the hassle of disassembly or disengagement of the capture device support structure 140.

In some embodiments, the second means for securing a capture device 150 includes a threaded camera mount such as those comprising a threaded screw, a retaining flap, and a twist knob. The second capture device may be pointed in a different direction than the first capture device. For example, the first capture device may serve as the POV camera, facing the same direction as the animal, and the second capture device may face the animal itself, potentially creating a 360-degree view. The second capture device may be secured in the same or a different manner than the first capture device and may or may not also have its own capture device support structure.

In alternative embodiments, at least one of the first means for securing a capture device 130 and the second means for securing a capture device 150 may be adapted to couple with a different apparatus, item, or device other than a capture device. For example, a treat holder, a pet toy, a squeaker, a flashlight or LED bulb, a charm or piece of aesthetic flair, straps for increasing security of the first and/or second capture devices, further securing mechanisms such as strap or structure to further secure the animal held media capture apparatus 100 to the animal, and so on.

In some embodiments, the apparatuses, items, or devices listed in the preceding paragraph may be coupled to the animal held media capture apparatus 100 through other means than one of the means for securing one of the capture devices. For example, a toy, a set of straps or other securing means to secure the animal held media capture apparatus 100 to the animal, means for increasing the securement of the capture device to the animal held media capture apparatus 100, etc.

In some embodiments, the second means for securing a capture device 150 may also include a threaded peg that the capture device is capable of coupling with, or it may be other coupling means including quick-release mechanisms/connectors, compression connectors, suction connectors, adhesive connectors, fasteners, and so on. In further embodiments, this second means for securing a capture device 150 may include a quick-release peg-and-hole connector common in many consumer capture devices such as GoPro™ that is encased in a protector including mounting means comprising a peg with clips or latches for a receiving hole and having a quick-release button to disengaged those clips or latches and remove the peg from the receiving hole.

In alternative embodiments, the animal held media capture apparatus 100 may be partially or fully modular, meaning that the elongated piece 110, the bite apparatus 120, the first means for securing a capture device 130, the capture device support structure 140, and/or the second means for securing a capture device 150 are all removable and/or swappable with other components. Having such modularity means that all pieces should use some sort of connection mechanisms whether it is peg-and-hole connections, snaps, screws, fasteners, hook-and-loop connectors, threaded pegs, zippers, clips, clamps, sliding locks, and other mechanisms common on consumer and pet products or products focused on use by animals.

In these modular embodiments, the user may, for example, detach the bite apparatus 120 in the form of a bite plate and replace it with a different bite apparatus such as a compressible sphere, a pet toy, or a tripod or stand that the animal held media capture apparatus 100 is adapted to couple with. Further, either the first or the second means for securing a capture device, or both, may be swappable to accommodate different capture devices or other items such as pet toys, feeders, and the like which would be focused on pet or animal use.

In some embodiments, the first means for securing a capture device and/or the capture device support structure, while modular, may be coupled with the elongated piece via universal connection mechanisms such as a slotted rail, a threaded peg, a quick-release peg-and-hole structure, and other common connection methods in consumer products so that the first means for securing a capture device and/or the capture device support structure may be removed from the animal held media capture apparatus and placed into a complimentary connection mechanism on another consumer item such as a tripod, stand, car mount, etc. This is beneficial so the user may transfer the capture device to another receptacle without having to remove the capture device from the first means for securing a capture device and/or the capture device support structure.

Observing an abundance of clarity, it should be understood that if a component of or the whole animal held medica capture apparatus is not modular, then it is made of a single piece (such as being entirely produced via injection molding techniques) or that the individual pieces are note designed to be uncoupled (for example, if the silicone bite apparatus is permanently affixed in a receiver in a hard plastic elongated piece).

The depicted embodiment features an orientation that aligns with the direction the animal is facing and in-line with the median down the animal from their head to their rear end. This “straight” orientation (aligned with the animal's spine) provides the most accurate animal POV. This orientation is not perpendicular or parallel to the animal, but the present invention could be practiced in such alternate orientations in other embodiments due to the structure and/or flexible materials of the animal held media capture apparatus. For example, the elongated piece may be made of flexible material similar to a “gooseneck” phone stand or holder. The gooseneck elongated piece could be oriented to aim the capture device in a deviated direction instead of the direct POV of the animal using the animal held media capture apparatus.

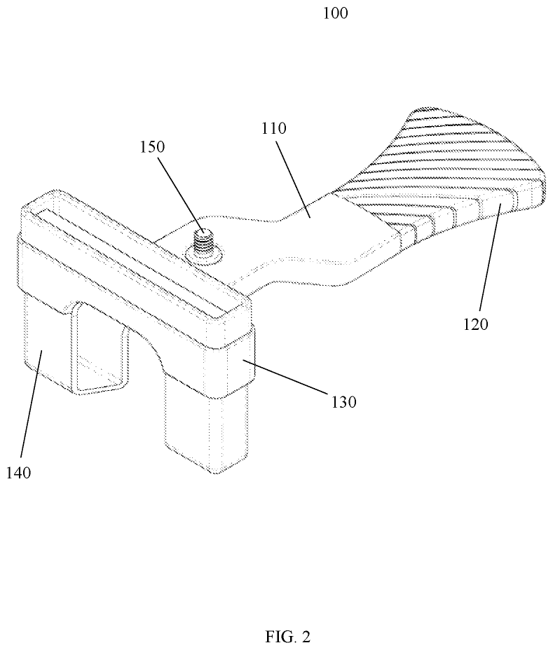

FIG. 2 is an isometric view of a top side of one embodiment of the present invention. In this embodiment, the second means for securing a capture device 150 is shown as a universal threaded camera mount which works with many commercial camera and recording products. The universal threaded camera mount often includes a retaining flap and a twist nod for rotating and/or securing the attached camera to the animal held media capture apparatus 100.

This embodiment also prominently displays the end of the capture device support structure 140 that receives the capture device (such as a cell phone). Notably, this version of the capture device support structure 140 will tightly grip the cell phone it was designed to fit when inserted into the first means for securing a capture device 130. This compression ideally prevents any movement while not being tight enough to damage said cell phone during the animal's use of the animal held media capture apparatus 100. This compression is achieved by inserting the cell phone into the capture device support structure prior to inserting it into the first means for securing a capture device 130. Alternative embodiments of the capture devices support structure 140 may include more generic fittings for capture devices such as cell phones. These generic fittings may include adjustable screws or clamps which are manipulated to snuggly fit capture devices of varying sizes and shapes.

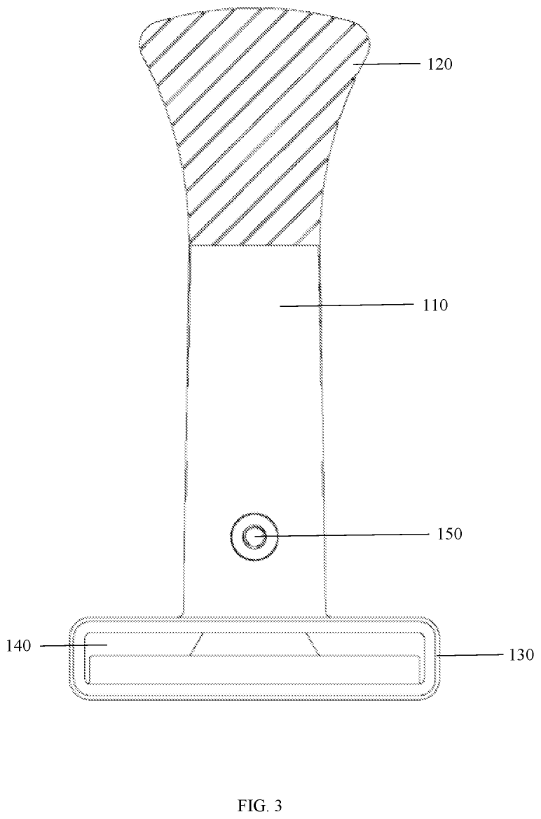

FIG. 3 is a view from above one embodiment of the present invention. In this embodiment, the elongated piece 110 is substantially straight. This view also shows that the bite apparatus 120 may be made of rubber and have diagonally aligned, grooves which provide some room for the animal's biting motion down on the bite apparatus 120 to deform the apparatus a bit without damaging the bite apparatus 120 or the animal's teeth or mouth. The grooves allow for the rubber of the bite apparatus 120 to be compressed in such a way that the bite apparatus 120 would retain a similar height instead of pushing back against the mouth of the animal biting the bite apparatus 120.

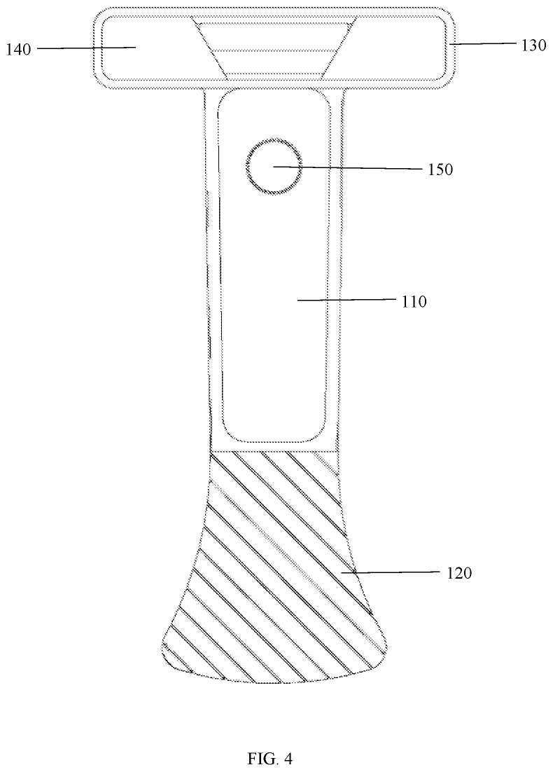

FIG. 4 is a view from below one embodiment of the present invention. This depiction prominently shows the twist knob that is used with the second means for securing a capture device 150 comprising a universal threaded camera mount.

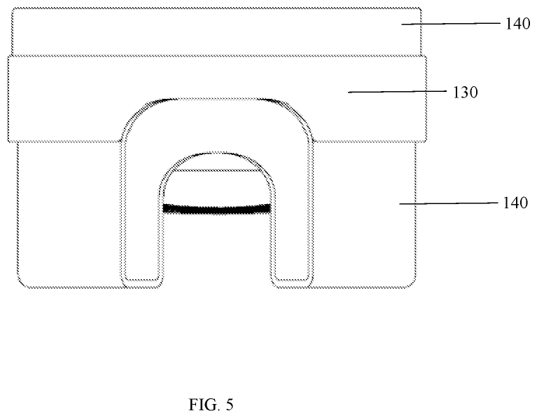

FIG. 5 is a view of a front of one embodiment of the present invention.

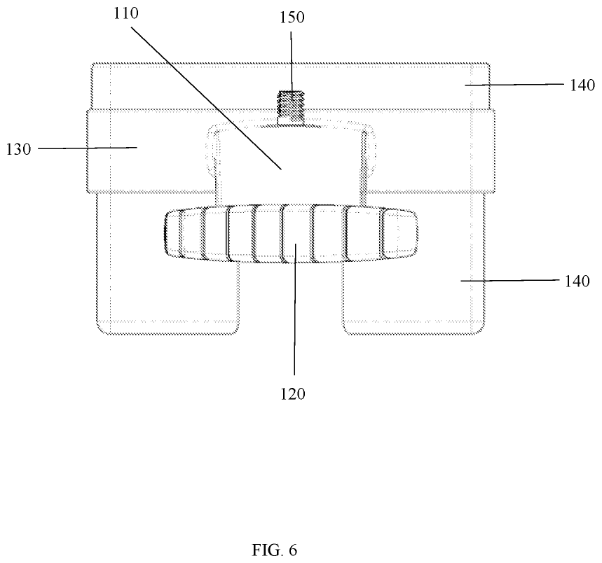

FIG. 6 is a view of a back of one embodiment of the present invention.

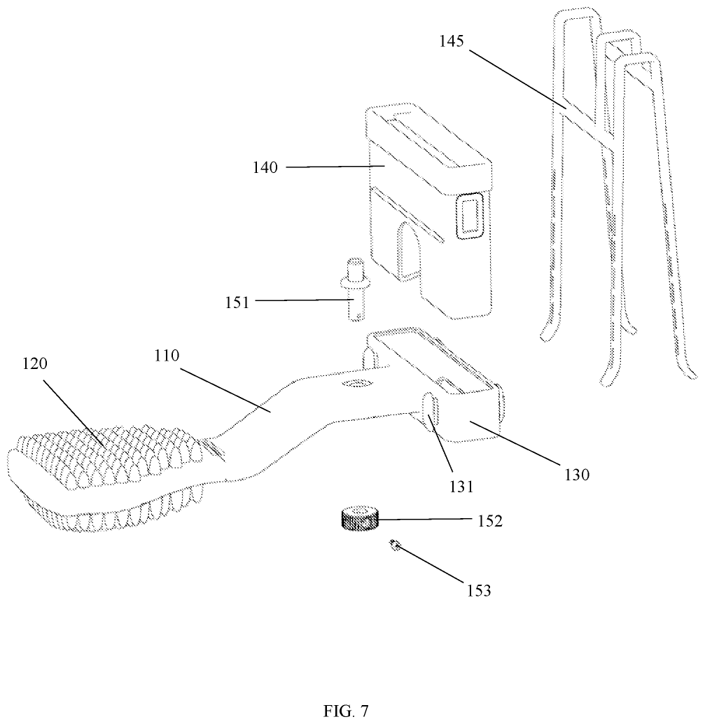

FIG. 7 is an exploded, isometric view of one embodiment of the present invention featuring additional security for a capture device. The depicted embodiment contains several additional features over the embodiment depicted in FIGS. 1-6.

In some embodiments, the bite apparatus 120 may include soft rubber or silicone spikes that provide tactile stimulation to the animal during use. Further, these spikes may be flavored. Further embodiments include features like pre-formed bite grooves, stimulating features such as a squeaker, and other attractants which compel the animal to engage and retain the bite apparatus within the animal's mouth.

The second means for securing a capture device 150 may be comprised of a mounting peg with a retainer 151, a twist knob 152, and a retaining screw 153. The mounting peg may be adapted as a universal adapter capable of mounting with many types of capture devices (such as cameras and cell phones) or it may be specially made for one or a few capture devices. Further, the elongated piece 110 may include a receiving hole for the mounting peg with a retainer 151 and then retainer may be a washer attached to the peg which prevents it from sliding through the receiving hole. Once the peg is placed through the hole, it is secured by the twist knob 152 and retaining screw. In some embodiments, the twist knob 152 may be enough and not require the retaining screw 153; however, the inclusion of both gives the twist knob 152 the functionality of rotating the attached capture device instead of only securing the mounting peg with a retainer 151 to the animal held media capture apparatus 100.

The capture device support structure 140 may include additional features such as a retaining flap that will not let it go completely through the first means for securing a capture device 130, a middle lip to add in this securement that fits just below the first means for securing a capture device 130, adjustable gauges to further secure the capture device, and an additional capture device support bracket 145 which fits over the capture device before it is inserted into the capture device support structure 140. This capture device support bracket 145 further ensures snug retainment of the capture device as well as preventing it from undesirably dislodging from the capture device support structure 140. The depicted embodiment includes a support bracket coupling mechanism 131 which allows the capture device support bracket 145 to apply downward pressure on the capture device while it is within the capture device support structure 140 which the support structure is engaged with the first means for securing a capture device 130. The depicted capture device support bracket 145 includes multiple slots that the support bracket coupling mechanism 131 can slide into in order to secure capture devices of varying heights and with varying amounts of downward force (the more you stretch the support bracket, the more force applied). The capture device support bracket 145 may be made of durable but somewhat elastic materials such as silicone or rubber.

In alternative embodiments, the capture device support structure 140 may have interior grooves adapted for guiding and/or coupling the capture device support bracket 145 to ensure an even more secure fit. Such security becomes increasingly desirable the more active and rougher the animal is on the animal held media capture apparatus 100.

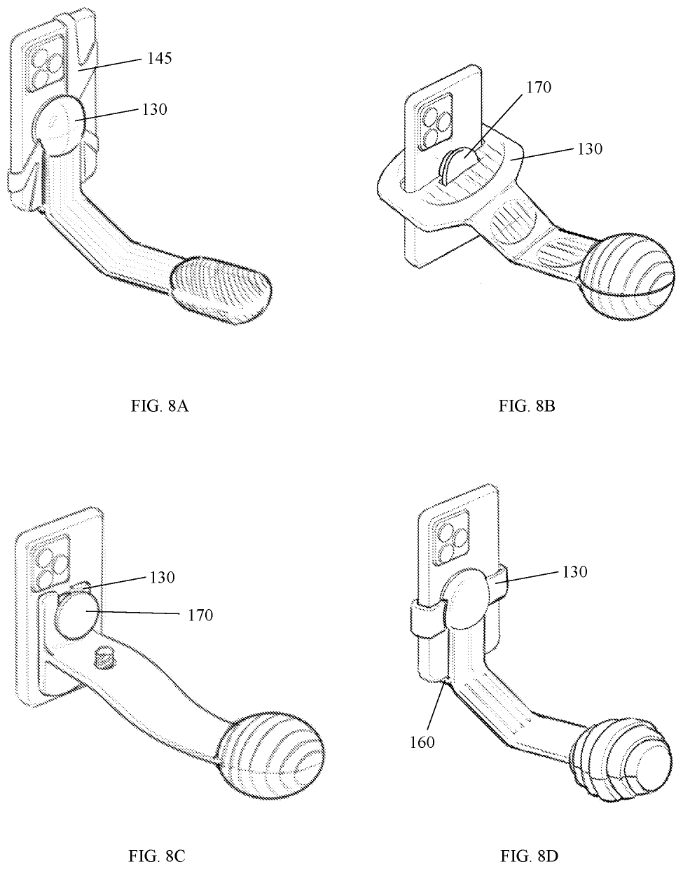

FIG. 8A-8D are multiple embodiments of the present invention featuring a variety of capture device connections and animal engagement mechanisms. The depicted embodiments show varieties of bite apparatuses (often in more spherical forms as to engage more of the animal's mouth), and a variety of first means for securing a capture device. Further, some of the embodiments lack a visible second means for securing a capture device because it is either attachable/detachable or on the bottom side of the elongated piece.

FIG. 8A features a capture device support bracket 145 that fully wraps the device before attaching the device to the first means for securing a capture device 130.

FIG. 8B displays a first means for securing a capture device that is adapted to couple with the capture devices attached accessory 170 (sometimes called, in some embodiments, a “Pop Socket™”). The first means for securing a capture device 130 is form cut to fit the normal dimensions of the Pop Socket™ and has an underline support cover which prevents the Pop Socket™ from sliding completely through the first means for securing a capture device 130. Further, because the Pop Socket™ is prevented from sliding completely through, the capture device will also be unable to slide completely through because it is securing attached to the Pop Socket™ via strong adhesion, mechanical or magnetic couplings, or because the Pop Socket™ is part of the capture devices protective case (i.e. the protective case that almost everyone uses on their cell phones). This embodiment further features the first means for securing a capture device 130 having a 360-degree protective bar. This prevents damage to the front of the capture device (the side pointing away from the animal) in case the animal held media capture apparatus is dropped by the animal, the animal runs it into a tree or fence, or other potential sources of damage.

FIG. 8C depicts another first means for securing a capture device adapted to couple with the capture devices attached accessory. This embodiment may feature a magnetic lock in addition to the structural adaption of the first means for securing a capture device 130 to hold a capture device's attached Pop Socket™ 170 (or other accessory). This magnetic lock is often called MagSafe™ or, more generically, magnetic ring in consumer products and said magnet provides utility and other features for the capture device (such as having a magnetic wallet, magnetic pop socket, magnetic charger, etc.).

FIG. 8D depicts a bottom plate that helps support the capture device. A bottom plate 160 may be used to provide additional stability to the capture device during use by preventing the device from descending from the grip of the first means for securing a capture device 130.

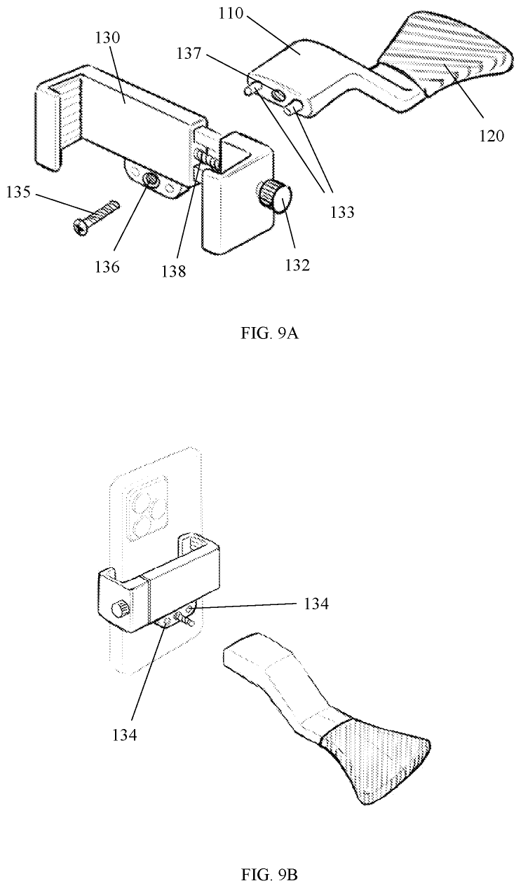

FIGS. 9A and 9B feature an embodiment of the present invention having a detachable first means for securing a capture device. The depicted embodiment includes a first means for securing a capture device 130 in the form of a C-clamp that is adjustable to fit a variety of capture devices. Further, the first means for securing a capture device 130 is adapted to have two receiving holes 134 for two pegs 133 from the elongated piece 110. These holes 134 and pegs 133 aid in preventing the first means for securing a capture device 130 from rotating after being coupled to the elongated piece 110. Alternative embodiments may have fewer or more holes and pegs for stability. Further, a fastener 135 may pass through a channel 136 in the first means for securing a capture device 130 before being fastened in a receiver 137 of the elongated piece 110, securing the C-clamp to the elongated piece 110. The C-clamp may be adjustable by rotating a knob 132 which extends or retracts the width of the C-clamp by a lengthening and shortening mechanism 138. The capture device may be secured by the C-clamp prior or after the C-clamp is secured to the elongated piece. Also, the C-clamp's interior (the portion that contacts the capture device) may include softer materials such as rubber or silicone that are less likely to damage the capture device than plastics or metal.

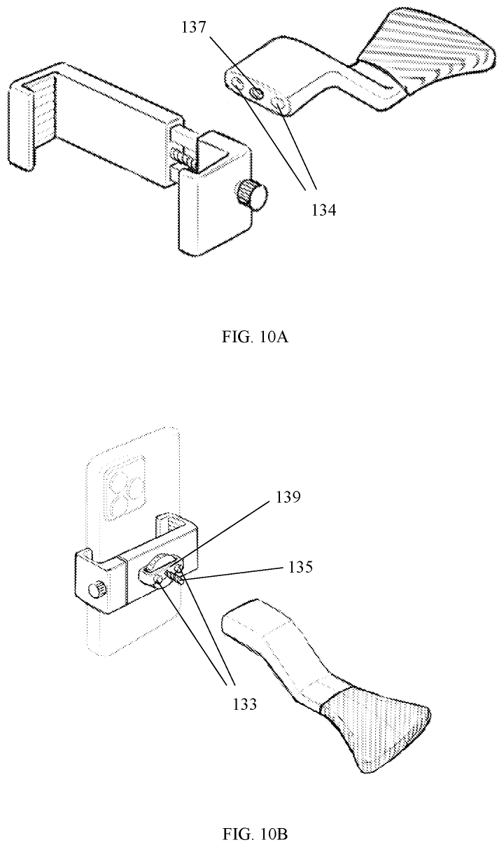

FIGS. 10A and 10B feature an embodiment of the present invention having a detachable first means for securing a capture device. Compared to FIGS. 9A and 9B, the key difference is that the fastener is permanently housed within a fastener mount 139 located on the back of the C-clamp. This prevents the fastener 135 becoming detached or lost from the C-clamp. Further, this embodiment swaps the position of the holes 134 and pegs 133 (placing the pegs 133 on the faster mount 139 and the holes 134 on the elongated piece 110).

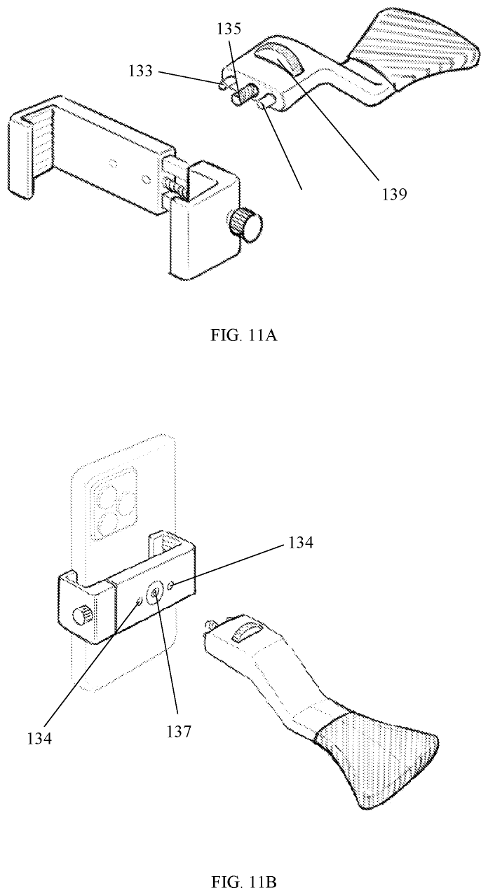

FIGS. 11A and 11B feature an embodiment of the present invention having a detachable first means for securing a capture device. Compared to FIGS. 10A and 10B, the key difference is that the fastener 135 and the fastener mount 139 are incorporated into the elongated piece 110, and the receiver 137 for the fastener is on the C-clamp.

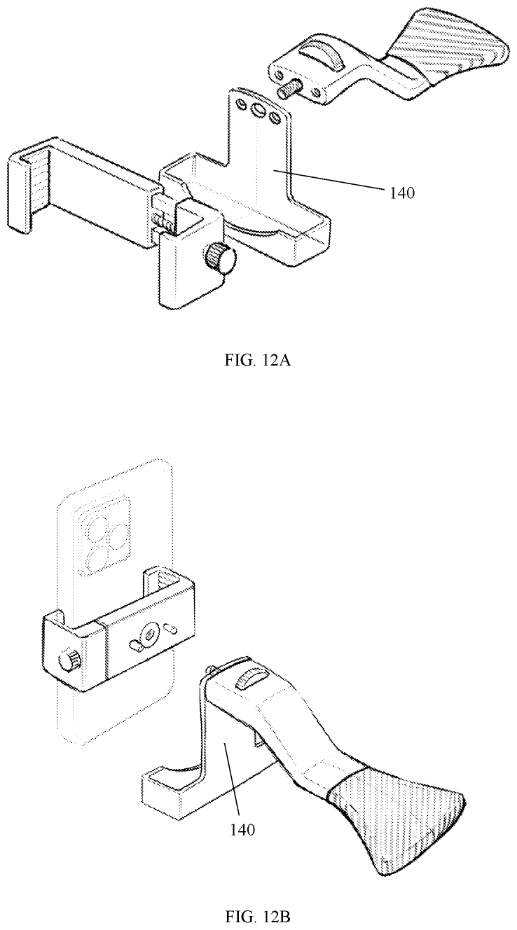

FIGS. 12A and 12B feature an embodiment of the present invention having a detachable first means for securing a capture device. The embodiment depicted in these figures is similar to FIGS. 11A and 11B; however, there is an inclusion of a capture device support structure 140 which is adapted to allow for the pegs 133 and fastener 135 to pass through spaces in the capture device support structure 140 prior to the C-clamp coupling with the elongated piece 110. This provides additional support for the capture device similar to the bottom plate of FIG. 8D.

In some embodiments the elongated piece 110 may be made of a flexible material that the user may adjust the shape and angle of the elongated piece 120 to allow for desired media capture and/or to allow the animal to easily see over or past the capture device(s) and supporting structure(s). In alternative embodiments, the elongated piece 110 may attach to a flexible piece which serves as an intermediary between the elongated piece 110 and the capture device support structure 140 or the elongated piece 110 and the bite apparatus 120. In even further alternative embodiments, the flexible piece may also be the same piece as the capture device support structure 140. This flexible piece should add at least some additional length while further allowing the user to orient the flexible piece into a desired position or orientation for the capture of media from the animals POV.

In further embodiments, the present invention may use a different bite apparatus in replacement of the previously described bite apparatus in the form of a bite plate. As with the bite plate, the animal will bite down on the alternative bite apparatus and the remaining components of the present invention will operate as previously described, this change only affects the animal's engagement (bite) with the present invention. Some exemplary bite apparatuses include, of course, a bite plate; a compressible sphere (or “ball”) or other shape; a malleable substrate; an attachable animal or pet toy having a connection method for connecting to the elongated piece via a structure or receiver for specialized or generic connection methods (straps, latches, hook-and-loop connectors, tethers, belts, button snaps, clamps, etc.); a mouth guard; and more. All bite apparatuses should be designed and constructed to satisfy the criteria of: (1) providing a desirably secure grip within the animal's mouth while engaged by the animal but allowing the animal to easily release the bite apparatus if desired; (2) providing a complimentary shape to the desired type of animal's or animals' bite (whether for the species or a specific animal); being made of durable materials capable of repeatedly enduring the bite of the animal without damage, lasting deformation, or other wear and tear; (3) being appealing for the animal to bite whether that is accomplished due to attractants such as tactile stimulation, flavor, smell, auditory stimulation, other attracting methods for encouraging the animal to engage with the bite apparatus, and combinations thereof; and (4) being replaceable and/or cleanable as the nature of some bite apparatuses may deem replacements necessary from time-to-time and having a replaceable bite apparatus may allow the other parts of the device to be used.

In some embodiments, the present invention may be composed of a bite apparatus (or bite plate) that is directly coupled with a means for securing a (first, second, or any) capture device (meaning that these versions have no elongated piece acting as an intermediary between the bite apparatus and means for securing a capture device). The bite apparatus, in such embodiments, may be adapted to couple with, house, engage, or include structures to comprise the means for securing a capture device. Examples include having clamps built onto the bite apparatus to hold the capture device, the bite apparatus having a threaded peg for capture devices with corresponding female threaded receiving structures, structures cable of receiving the capture device and including a “quick-release” mechanism which allows the user to disengage the capture device, etc. These embodiments of the present invention benefit from typically having smaller sizes and weights which may accommodate smaller animals who lack the muscle or mouth size to properly engage with the bite apparatus and move unencumbered while using the present invention.

In some embodiments, the animal held media capture apparatus 100 may work with a specialized application available for connectivity with a capture device. This application may allow the user to operate the one or two capture devices in tandem so long as the capture devices are operably connected to the application via a network or other connectivity method such as Bluetooth™. The application may instruct the capture devices to record, stop recording, record in tandem, record in a front-and-back orientation (if one or both of the capture devices are capable of recording in more than one direction, such as a cell phone having front and back cameras), change other recording settings, change image settings, and so forth.

In some embodiments, the animal held media capture apparatus 100 may be capable of, and the user decides to, attaching aesthetic trinkets that are either purely aesthetic for humans or stimulating or attractive to the animal.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal held media capture apparatus comprising:
an elongated piece having two distal ends;
a bite apparatus on one distal end of the elongated piece and the bite apparatus being designed be engaged by an animal and is adapted to encourage that engagement and promote retainment within the animal's mouth;
a first means for securing a capture device on the other distal end of the elongated piece opposite the bite apparatus;
a second means for securing a capture device to the elongated piece between the two distal ends; and
wherein the animal held media capture apparatus is made of animal safe materials.

2. The animal held media capture apparatus of claim 1, wherein the elongated piece is flexible and allows a user adjust the elongated piece into a desired orientation.

3. The animal held media capture apparatus of claim 1, wherein the bite apparatus includes at least one attractant.

4. The animal held media capture apparatus of claim 3, wherein the attractant is a flavoring that is incorporated into the material comprising the bite apparatus.

5. The animal held media capture apparatus of claim 3, wherein the attractant is a structure constructed to positively stimulate the animal's mouth when the animal engages with the bite apparatus and encourage the animal to continue biting the bite apparatus so that the animal held media capture apparatus may be used to capture media from the animal's point-of-view.

6. The animal held media capture apparatus of claim 1, further comprising a capture device support structure having an interior adapted to receive a capture device and an exterior to provide protection to the that capture device capture device and operably couple with the first means for securing a capture device.

7. The animal held media capture apparatus of claim 1, wherein at least two of the elongated piece, the bite apparatus, the first means for securing a capture device, and the second means for securing a capture device are modular and are adapted to include at least one connection mechanism between the pieces that are modular.

8. The animal held media capture apparatus of claim 7, wherein the elongated piece and the bite apparatus are modular and may be disengaged from one another and individually attached to a flexible piece adapted to couple with the bite apparatus connection mechanism and the elongated pieces connection mechanism so that the flexible piece is between the bite apparatus and the elongated piece, and wherein the flexible piece is malleable and allows a user adjust the flexible piece into a desired orientation.

9. The animal held media capture apparatus of claim 7, wherein the elongated piece and the first means for securing a capture device are modular and may be disengaged from one another and individually attached to a flexible piece adapted to couple with the first means for securing a capture device connection mechanism and the elongated pieces connection mechanism so that the flexible piece is between the first means for securing a capture device and the elongated piece, and wherein the flexible piece is malleable and allows a user adjust the flexible piece into a desired orientation.

10. The animal held media capture apparatus of claim 1, wherein in the first means for securing a capture device is a flexible piece that is malleable and allows a user adjust the flexible piece into a desired orientation.

11. The animal held media capture apparatus of claim 1, wherein the bite apparatus is a bite plate having soft, rounded-tip silicone spikes with flavoring added within the silicone during manufacture.

12. The animal held media capture apparatus of claim 1, further comprising a structure on the elongated piece that is adapted to couple with a consumer product.

13. The animal held media capture apparatus of claim 1, wherein the elongated piece includes a structure for receiving a consumer product featuring a peg-and-hole coupling mechanism including a quick-release button.

14. The animal held media capture apparatus of claim 13, wherein the structure for receiving a consumer product is the second means for securing a capture device.

15. The animal held media capture apparatus of claim 1, wherein the bite apparatus, the elongated piece, and the first means for securing a capture device are arranged in a straight orientation in relation to the direction that the animal is facing.

16. An animal held media capture apparatus comprising:
a bite apparatus having two distal ends and wherein one distal end is engaged by an animal and is adapted to encourage that engagement and promote retainment within the animal's mouth;
a first means for securing a capture device on the other distal end of the bite apparatus not engaged by the animal and adapted to receive a capture device to provide media from the animal's point-of-view; and
wherein the animal held media capture apparatus is made of animal safe materials.

17. The animal held media capture apparatus of claim 16, further comprising a second means for securing a capture device located on the bite apparatus and not inside the animal's mouth while the animal engages with the bite apparatus.

18. The animal held media capture apparatus of claim 16, further comprising a capture device support structure having an interior adapted to receive a capture device and an exterior to provide protection to the that capture device and operably couple with the first means for securing a capture device.

19. The animal held media capture apparatus of claim 16, wherein the bite apparatus includes at least one attractant.

20. The animal held media capture apparatus of claim 16, wherein the bite apparatus is a bite plate having soft, rounded-tip silicone spikes with flavoring added within the silicone during manufacture.
